(19) United States
(12) Patent Application Publication
(10) Pub. No.: US 2020/0114191 A1
(43) Pub. Date: Apr. 16, 2020

(54) AUXILIARY ARM OF BARBELL HANGER

(71) Applicant: Ya-Chi CHEN, New Taipei City (TW)

(72) Inventor: Ya-Chi CHEN, New Taipei City (TW)

(21) Appl. No.: 16/160,275

(22) Filed: Oct. 15, 2018

(51) Int. Cl. A63B 21/078; F16M 13/02; F16B 45/00; A63B 71/00

(52) U.S. Cl. CPC A63B 21/078; F16M 13/022; F16B 45/00; A63B 21/0724; F16M 2200/066; F16M 2200/028; A63B 71/0036

(57) ABSTRACT

An auxiliary arm of a barbell hanger mainly includes: a mounting seat including a positive abutting surface, a lateral abutting surface and a back abutting surface, and the mounting seat has a mounting portion, the mounting portion is selectively combined and positioned in any positioning portion of the barbell hanger; a laterally curved bracket is laterally convexly provided at the lateral abutting surface, and the laterally curved bracket has a first section, a second section and a curved section, wherein the end of the second section is provided with a barbell receiving frame, and the barbell receiving frame has the relative relationship of a forward-backward offset distance and a lateral offset relative to the mounting seat; a bar avoidance space formed jointly by the first section, the second section and the curved section of the laterally curved bracket are defined by the concave space.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

### Field of the Invention

The present invention relates to a set of barbell hangers, and more particularly to an innovative auxiliary arm structure type revealer, which is used for a barbell hanger.

### Description of Related Art Including Information Disclosed Under 37 CFR 1.97 and 37 CFR 1.98.

In the actual application of the barbell hanger, the structural type design of the barbell hanger is generally accepted because the barbell with considerable weight must be firmly supported. Not only does the hanger mostly adopts the massive hollow metal tube, but also the bottom end of both left and right sides of the tube is usually fixed on the floor through a bolt lock assembly.

The spacing between the left and right sides of the barbell hanger is not arbitrarily set. It must be determined according to the standard length specification of the barbell. However, the grip bar length of the barbell is not limited to one type. The Olympic standard is used as example, the standard length of the male bar is 220 cm, and the standard length of the female bar is 201 cm. It can be seen that if the barbell hanger is set to meet the optimal placement requirements of the above two length specifications, it is obvious that at least three tubes to be installed and two different spaces to be configured can meet the above functional requirements, but this will inevitably lead to the problem of occupying space, because the barbell hangers are generally set in the gymnasium environment, and many sports and fitness equipment must be set in the limited space of the gymnasium. If the large space is occupied by setting the barbell hanger, it obviously affects the relevant industry's optimal configuration planning requirements for the flexibility of the fitness space and the movable space.

### BRIEF SUMMARY OF THE INVENTION

The present invention mainly aims to provide the auxiliary arm of the barbell hanger, and the technical problem to be solved is to develop a new type of auxiliary arm structure type for the barbell hanger which is more ideal and practical, and it is an innovative breakthrough. The mentioned auxiliary arm is mounted on a barbell hanger structure for changing the spacing between the spanning support points of the barbell, the barbell hanger has a front side, a back side and two sides, and the barbell is provided with plural positioning parts arranged in an upper and lower interval.

Based on the foregoing objective, the technical feature of the present invention is mainly to solve the problem, and the auxiliary arm system comprises: a mounting seat, comprising a positive abutting surface connected by a front-to-back zigzag, a lateral abutting surface and a back abutting surface, wherein the positive abutting surface abuts against the front surface of the barbell hanger, the back abutting surface abuts against the back of the barbell hanger, and the lateral abutting surface abuts against one side of the barbell hanger, and the mounting seat has a mounting portion, which is selectively combined and positioned in any positioning portion provided by the barbell hanger; a laterally curved bracket to be laterally convexly shaped is provided at the lateral abutting surface of the mounting seat, and the laterally curved bracket comprises a first section, a second section and a curved section, wherein the second section end is provided with a barbell receiving frame, and the barbell receiving frame has the relative relationship of a forward-backward offset distance and a lateral offset relative to the mounting seat; a bar avoidance space formed jointly by the first section, the second section and the curved section of the laterally curved bracket are defined by the concave space.

With this innovative and unique design, the invention can be compared with the prior technology, so that the barbell hanger can be used with another barbell spanning support point spacing selection, and under the condition that the barbell hanger can be placed without changing the original set spacing and only by adding the auxiliary arm, the multi-functional requirement of the barbells with two different length is practical and progressive and it has better industrial utilization benefit.

Another objective of the present invention is to further provide another technical feature of a reinforcing support rib between the lateral abutting surface and the first section of the laterally curved bracket, so that the laterally curved bracket can get the stronger and un-deformable force strength.

### BRIEF DESCRIPTION OF THE SEVERAL VIEWS OF THE DRAWINGS

FIG. 1 is a combined three-dimensional diagram of a preferred embodiment of a barbell hanger of the present invention.

FIG. 2 is a partial three-dimensional diagram of a preferred embodiment of a barbell hanger of the present invention.

FIG. 3 is a decomposition state three-dimensional diagram of the auxiliary arm and barbell hanger of the present invention.

FIG. 4 is a partial structure combined sectional view of a preferred embodiment of the auxiliary arm of the present invention.

FIG. 5 is a sectional pattern embodiment 1 of laterally curved bracket and reinforcing support rib of the present invention.

FIG. 6 is a sectional pattern embodiment 2 of laterally curved bracket and reinforcing support rib of the present invention.

FIG. 7 is a sectional pattern embodiment 3 of laterally curved bracket and reinforcing support rib of the present invention.

FIG. 8 is a top view of barbell spanning state embodiment 1 of the auxiliary arm of the present invention.

FIG. 9 is a top view of barbell spanning state embodiment 2 of the auxiliary arm of the present invention.

### DETAILED DESCRIPTION OF THE INVENTION

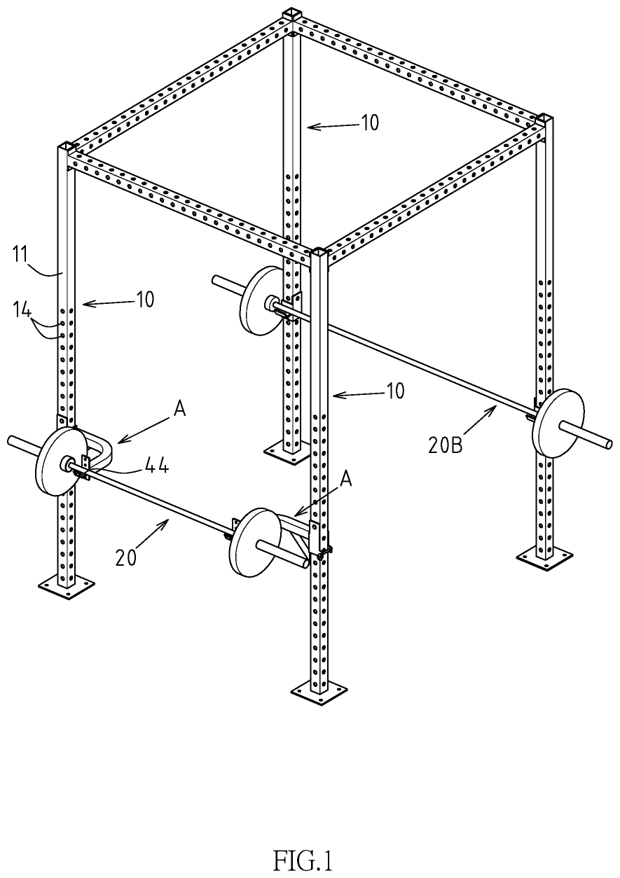

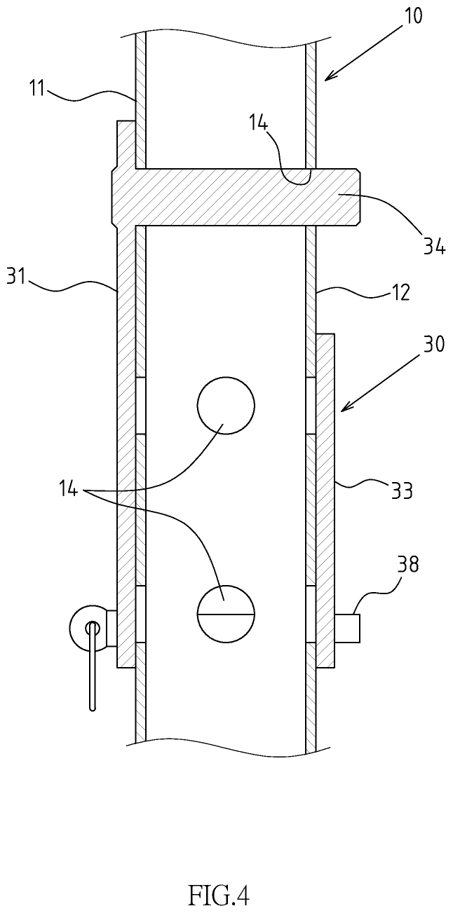

Referring to FIGS. 1, 2, 3, 4, and 5 for a preferred embodiment of the auxiliary arm of the barbell hanger of the present invention. However, these embodiments are for illustrative purposes only and are not limited to this structure in the patent application.

The mentioned auxiliary arm A is mounted on a barbell hanger 10 structure, so as to change the spacing between the spanning support points of the barbell 20, and the barbell hanger 10 has a front surface 11, a back surface 12 and two side surfaces 13, and the barbell hanger 10 is provided with the plural positioning portions 14 arranged in an upper and lower interval; the auxiliary arm A consists of the following structure: a mounting seat 30 comprising a positive abutting surface 31, a lateral abutting surface 32 and a back abutting surface 33, which are connected in a zigzag manner from front to back. The positive abutting surface 31 abuts against the front surface 11 of the barbell hanger 10, and the back abutting surface 33 abuts against the back surface 12 of the barbell hanger 10, and the lateral abutting surface 32 abuts against the one side surface 13 of the barbell hanger 10, and the mounting seat 30 has a mounting portion 34, the mounting portion 34 is selectively combined and positioned in any of the positioning portion 14 of the barbell hanger 10; A laterally curved bracket 40 is disposed on the lateral abutting surface 32 of the mounting bracket 30 in a laterally convex type. The laterally curved bracket 40 includes a first section 41, a second section 42 and a curved section 43 connected between the section 41 and the second section 42, wherein a barbell receiving frame 44 is disposed at the end of the second section 42, and the barbell receiving frame 44 has the relative relationship of a forward-backward offset distance and a lateral offset relative to the mounting seat; a bar avoidance space 50 formed jointly by the first section 41, the second section 42 and the curved section 43 of the laterally curved bracket 40 are defined by the concave space.

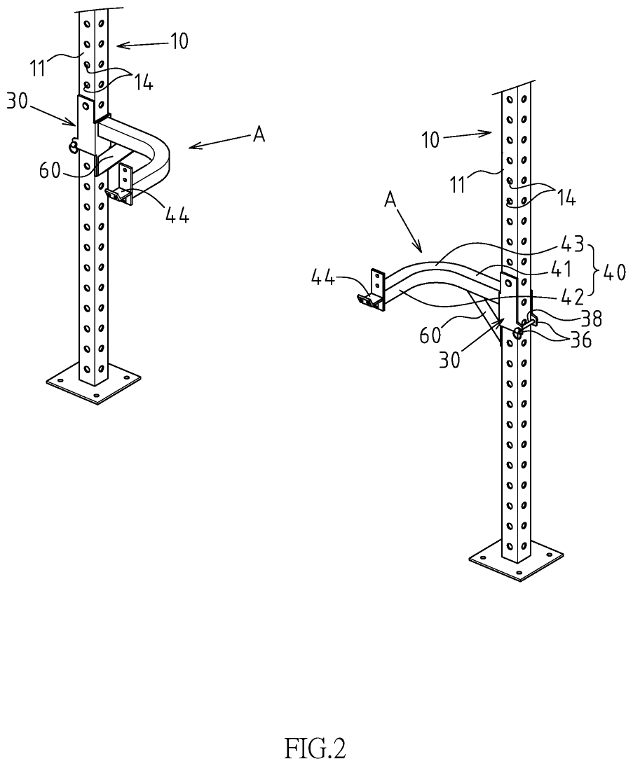

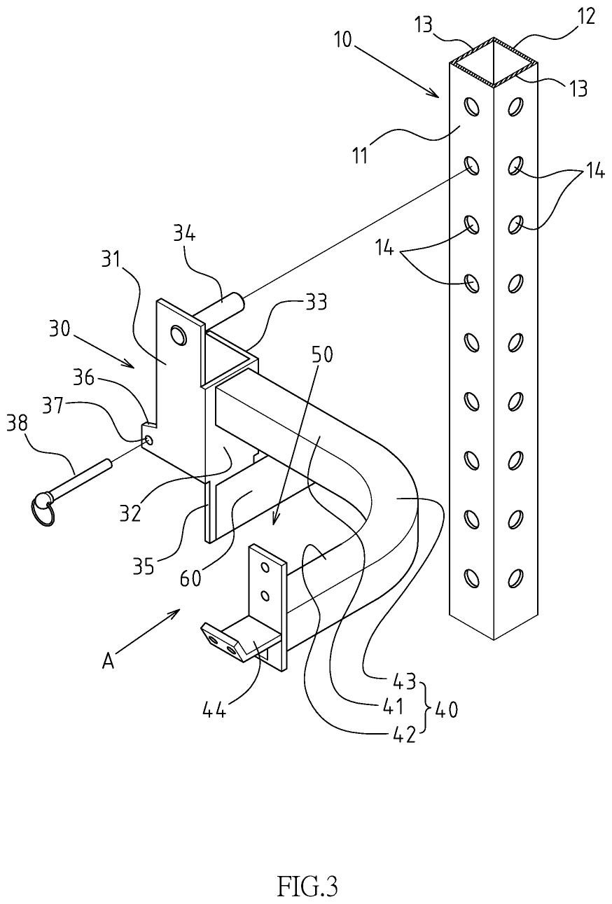

As shown in FIGS. 2 and 3, in this example, a reinforcing support rib 60 is further disposed between the lateral abutment surface 32 and the first section 41 of the laterally curved bracket 40; the addition of the reinforcing support rib 60 can mainly make the laterally curved bracket 40 obtain a stronger and un-deformable force strength.

As shown in FIG. 3, in this example, the bottom end of the lateral abutting surface 32 of the mounting base 30 is further extended downward by a length and an area to form a lower extending edge portion 35, so that the reinforcing supporting rib 60 is connected between the lower extending edge portion 35 and the first section 41 of the laterally curved bracket 40.

As shown in FIG. 3, in this example, the positioning portion 14 of the barbell hanger 10 is a hole type, and the mounting portion 34 of the mounting seat 30 disposed in the auxiliary arm A is a latch type protruding from the positive abutting surface 31.

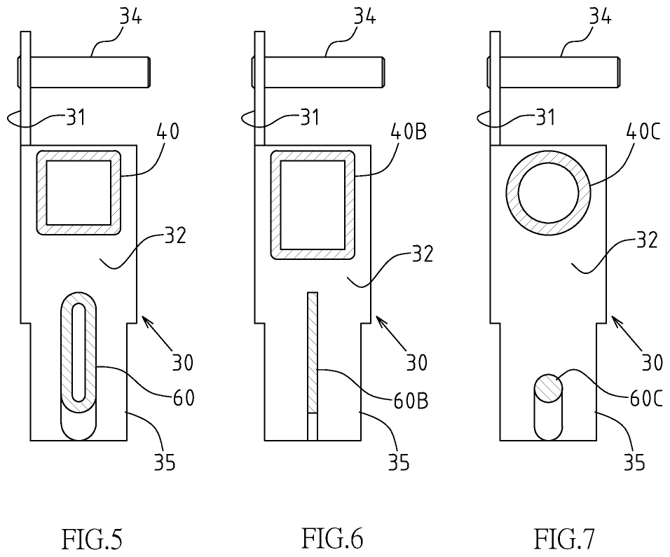

As shown in FIG. 3 (referring to FIG. 2), in this example, the back abutting surface 33 and the positive abutting surface 31 away from one side of the lateral abutting surface 32 are respectively provided with one lug 36 of the relative position, and the two lugs 36 are provided with two pin holes 37 of the relative position for a pin 38 to be inserted to assist in limiting the mounting seat 30.

Wherein, the laterally curved bracket 40 is formed by using a square tube, a rectangular tube, a circular tube, an elliptical tube or a flat tube as one of the metal pipes, and the portion is a laterally curved bracket 40 as shown in FIG. 5. It adopts a square tube type, and the laterally curved bracket 40B shown in FIG. 6 adopts a rectangular tube type; and the laterally curved bracket 40C shown in FIG. 7 is a circular tube type.

Wherein, the reinforcing support rib 60 is made of the pipe, and the solid rod or the sheet is composed of a rigid material, and the cross-sectional shape thereof is square, rectangular, circular, elliptical, polygonal or flat. The reinforcing support rib 60 shown in FIG. 5 adopts the flat tube; and the reinforcing support rib 60B shown in FIG. 6 adopts the sheet; the reinforcing support rib 60C shown in FIG. 7 adopts the solid round bar.

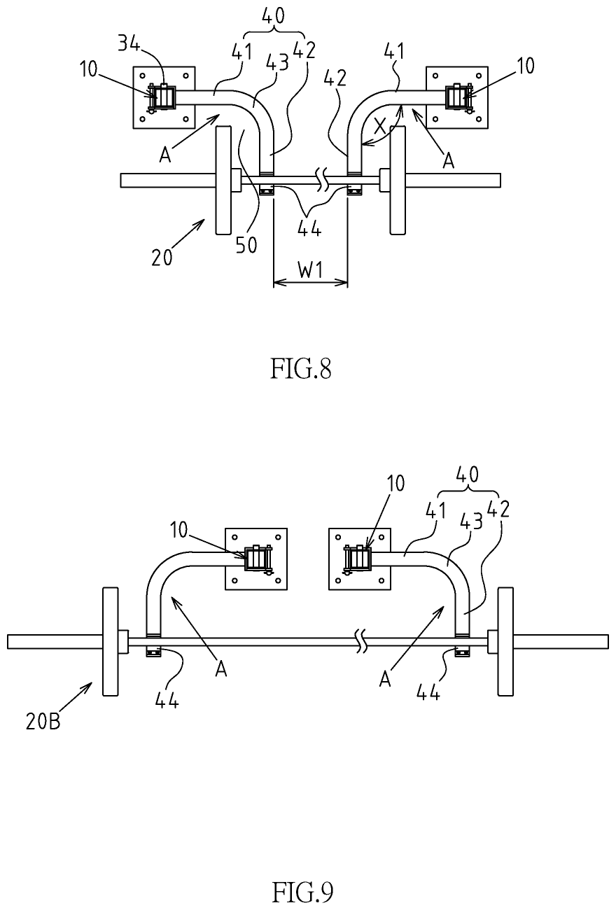

As shown in FIG. 8, in this example, the angle formed between the first section 41 and the second section 42 of the laterally curved bracket 40 through the curved section 43 (shown as X) is 90°.

With the above structural composition and technical features, the auxiliary arm A of the present invention is actually applied to the structure of a barbell hanger 10, as shown in FIG. 1. The advantage of inventing the auxiliary arm A is mainly to provide another barbell spanning support point spacing. Taking the state shown in FIG. 1 as an example, it is assumed that the spacing between the two barbell hangers 10 is set to be used for span-placing the longer male barbell 20B (e.g., 220 cm), the auxiliary arm A of the present invention is added, because the auxiliary arms A are arranged in pairs, and the second section 42 end of the laterally curved bracket 40 is provided with the barbell receiving frame 44, which is capable of retracting the spacing between the spanning support points of the barbell 20 (as shown by W1 in FIG. 8), so that the female barbell 20 with a relatively short length (e.g., 201 cm) can be placed. In this way, under the premise that the spacing between the two barbell hangers 10 does not need to be changed and the different spacing barbell hangers 10 need not to be additionally disposed, only the auxiliary arm A needs to be added, so that the barbell hanger 10 can meet the multi-functional requirements of placing barbells 20, 20B of two different length (refer to the state shown in FIG. 1), thereby it can substantially reduce the volume and cost of setting barbell rack 10, so that the fitness environment can be more spacious, more conducive to manager for flexible use of space planning.

Further, as shown in FIG. 9, assuming that the spacing between the two barbell hangers 10 in the preceding paragraph is used for placing the female barbell 20 with shorter length, through another changed installation type of the auxiliary arm A of the present invention, it can provide the male barbell 20B with longer length for placement; this example is for illustration, the actual installation type of the auxiliary arm A of the present invention includes the different types shown in FIGS. 8 and 9.

I claim:

1. An auxiliary arm of a barbell hanger, the mentioned auxiliary arm is mounted on a barbell hanger structure, so as to change a spacing between the spanning support points of the barbell, the barbell hanger has a front side, a back side and two side surfaces, and the barbell hanger is provided with the plural positioning portions arranged in the upper and lower interval; the auxiliary arm comprising:
a mounting seat comprises a positive abutting surface connected in a zigzag manner from front to back, a lateral abutting surface and a back abutting surface, wherein the positive abutting surface abuts against the front surface of the barbell hanger, the back abutting surface abuts against the back surface of the barbell hanger, the lateral abutting surface abuts against one side of the barbell hanger, and the mounting seat has a mounting portion, the mounting portion is selectively combined and positioned in any positioning portion of the barbell hanger;
a laterally curved bracket is disposed on a lateral abutting surface of the mounting bracket in a lateral convex type, the laterally curved bracket includes a first section, a second section and a curved section connected between the first section and the second section, wherein the end of the second section is provided with a barbell receiving frame, and the barbell receiving frame has the relative relationship of a forward-backward offset distance and a lateral offset relative to the mounting seat; and
a bar avoidance space formed jointly by the first section, the second section and the curved section of the laterally curved bracket are defined by the concave space.

2. The auxiliary arm of barbell hanger defined in claim 1, wherein the lateral abutting surface and the first section of the laterally curved bracket are further connected with a reinforcing support rib.

3. The auxiliary arm of barbell hanger defined in claim 2, wherein the bottom end of the lateral abutment surface of the mounting seat is further extended downward by a length and an area to form a lower extending edge portion, so that the reinforcing supporting rib is connected between the lower extending edge portion and the first section of the laterally curved bracket.

4. The auxiliary arm of barbell hanger defined in claim 3, wherein the positioning portion of the barbell hanger is a hole type, and the mounting portion of the mounting seat disposed in the auxiliary arm A is a latch type protruding from the positive abutting surface.

5. The auxiliary arm of barbell hanger defined in claim 4, wherein the back abutting surface and the positive abutting surface away from one side of the lateral abutting surface are respectively provided with one lug of the relative position, and the two lugs are provided with two pin holes of the relative position for a pin to be inserted to assist in limiting the mounting seat.

6. The auxiliary arm of barbell hanger defined in claim 5, wherein the laterally curved bracket is formed by using a square tube, a rectangular tube, a circular tube, an elliptical tube or a flat tube as one of the metal pipes.

7. The auxiliary arm of barbell hanger defined in claim 6, wherein the reinforcing support rib is made of the pipe, and the solid rod or the sheet is composed of a rigid material, and the cross-sectional shape thereof is square, rectangular, circular, elliptical, polygonal or flat.

8. The auxiliary arm of barbell hanger defined in any of claims 1, wherein the angle formed between the first section and the second section of the laterally curved bracket through the curved section is 90°.

9. The auxiliary arm of barbell hanger of claim 2, wherein the angle formed between the first section and the second section of the laterally curved bracket through the curved section is 90°.

10. The auxiliary arm of barbell hanger of claim 3, wherein the angle formed between the first section and the second section of the laterally curved bracket through the curved section is 90°.

11. The auxiliary arm of barbell hanger of claim 4, wherein the angle formed between the first section and the second section of the laterally curved bracket through the curved section is 90°.

12. The auxiliary arm of barbell hanger of claim 5, wherein the angle formed between the first section and the second section of the laterally curved bracket through the curved section is 90°.

13. The auxiliary arm of barbell hanger of claim 6, wherein the angle formed between the first section and the second section of the laterally curved bracket through the curved section is 90°.

14. The auxiliary arm of barbell hanger of claim 7, wherein the angle formed between the first section and the second section of the laterally curved bracket through the curved section is 90°.
